(19) United States
(12) Patent Application Publication
(10) Pub. No.: US 2022/0068540 A1
(43) Pub. Date: Mar. 3, 2022

(54) Strain Relief Mounting Surface For Ferrite Cores

(71) Applicant: Waymo LLC, Mountain View, CA (US)

(72) Inventor: Christopher Cheng, Mountain View, CA (US)

(21) Appl. No.: 17/006,408

(22) Filed: Aug. 28, 2020

(51) Int. Cl. H01F 27/06; H01F 27/24; H01F 41/02

(52) U.S. Cl. CPC H01F 27/06; G01S 7/481; H01F 41/0206; H01F 27/24

(57) ABSTRACT

An example device includes a mounting surface including a first material having a first coefficient of thermal expansion (CTE). The device includes an intermediate plate coupled to the mounting surface and comprising a second material having a second CTE. The device includes a ferrite core coupled to the intermediate plate and comprising a third material having a third CTE, wherein the second CTE of the intermediate plate is between the first CTE of the mounting surface and the third CTE of the ferrite core.

### BACKGROUND

Unless otherwise indicated herein, the materials described in this section are not prior art to the claims in this application and are not admitted to be prior art by inclusion in this section.

A device having rotating components, such as a gyroscopic sensing module, a rotating radar, a rotating camera, a rotating antenna, or a Light Detection and Ranging (LIDAR) device may include a stationary end and a rotating end which are separated by a space. A transformer may be used to transfer power and/or data between the stationary end and the rotating end. Some transformers may include brittle materials, such as ferrite cores that are prone to breaking or chipping in response to an applied strain. Differences in thermal expansion properties between the transformer and a surface on which it is mounted may be a source of such strain experienced by the transformer when the device encounters a change in thermal conditions.

### SUMMARY

In a first example, a device provided. The device includes a mounting surface including a first material having a first coefficient of thermal expansion (CTE). The device includes an intermediate plate coupled to the mounting surface and comprising a second material having a second CTE. The device includes a ferrite core coupled to the intermediate plate and comprising a third material having a third CTE, wherein the second CTE of the intermediate plate is between the first CTE of the mounting surface and the third CTE of the ferrite core.

In a second example, an intermediate plate is provided. The intermediate plate includes an outer portion coupled to a mounting surface, wherein the mounting surface comprises a first material having a first coefficient of thermal expansion (CTE). The intermediate plate includes a center portion coupled to a ferrite core. The outer portion and the center portion each include a second material having a second CTE. The ferrite core includes a third material having a third CTE, and the second CTE of the intermediate plate is between the first CTE of the mounting surface and the third CTE of the ferrite core.

In a third example, a method is provided. The method includes coupling an intermediate plate to a mounting surface. The mounting surface comprises a first material having a first coefficient of thermal expansion (CTE), and the intermediate plate comprises a second material having a second CTE. The method includes mounting a ferrite core on the intermediate plate. The ferrite core includes a third material having a third CTE, and the second CTE of the intermediate plate is between the first CTE of the mounting surface and the third CTE of the ferrite core.

In a fourth example, a non-transitory computer readable medium is provided. The non-transitory computer readable medium has instructions stored thereon that, when executed by one or more processors, cause performance of functions. The functions include causing an implement to couple an intermediate plate to a mounting surface. The mounting surface comprises a first material having a first coefficient of thermal expansion (CTE), and the intermediate plate comprises a second material having a second CTE. The functions include causing an implement to mount a ferrite core on the intermediate plate. The ferrite core includes a third material having a third CTE, and the second CTE of the intermediate plate is between the first CTE of the mounting surface and the third CTE of the ferrite core.

### BRIEF DESCRIPTION OF THE FIGURES

FIG. 1 is a block diagram of a device, according to an example embodiment.

FIG. 2 illustrates a perspective view of a system, according to an example embodiment.

FIG. 3A illustrates an exploded view of a system in first thermal conditions, according to an example embodiment.

FIG. 3B illustrates an exploded view of a system in second thermal conditions, according to an example embodiment.

FIG. 3C illustrates an intermediate plate in the second thermal conditions, according to an example embodiment.

FIG. 4 is a block diagram of a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to he limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

### I. Overview

A device having rotating components, such as a gyroscopic sensing module or a LIDAR device, may wirelessly transmit data and/or power from a stationary portion of the device to a rotating portion. This wireless transmission may be accomplished using a transformer having a ferrite core. Modulating a signal across the transformer allows for data and/or power to travel wirelessly to and from components on the rotating portion.

The ferrite core can he mounted to a relatively stationary portion of a system. For example, in the context of a vehicle, the ferrite core can be mounted to a surface on the vehicle, such as an aluminum surface. Because the ferrite core is mounted in a stationary manner relative to the mounting surface, the ferrite core can be exposed to mechanical forces whenever the mounting surface experiences a change in thermal conditions. In particular, this may result from different coefficients of thermal expansion (CTEs) between the mounting surface and the ferrite core. In some contexts, this may result in overstraining or breaking the ferrite core or a housing of the ferrite core.

In an example embodiment, the device includes an intermediate plate that reduces strain imparted on the ferrite core as a result of thermal expansion of the mounting surface. The intermediate plate has a CTE that is between a CTE of the mounting surface and a CTE of the ferrite Core. In this manner, when exposed to increasing temperatures, the mounting surface imparts a total mechanical force to the intermediate plate, and only a portion of the total mechanical force is imparted from the intermediate plate to the ferrite core. Accordingly, the amount of strain in the ferrite core is reduced, and the ferrite core is less likely to break.

In an example embodiment, the intermediate plate is configured to minimize lateral movement of the ferrite core relative to the mounting surface when the mounting surface is exposed to increasing temperatures. In particular, the intermediate plate can include an outer portion that is coupled to the mounting surface and a center portion to which the ferrite core is mounted. The outer portion is configured to deform away from the center portion while the center portion remains relatively stationary, allowing the ferrite core to remain aligned with a rotating portion of the device. in this manner, data and/or power transfer can be maintained while thermal conditions of the device change.

In an example embodiment, the outer portion of the intermediate plate includes a plurality of arms that extend in a helical orientation from the center portion. In this manner, the arms can operate as a spiral spring and allow the center portion to remain relatively stationary over a range of thermal conditions.

In an example embodiment, a material can be selected for the intermediate plate such that the CTE of the intermediate plate is between a CTE of the mounting surface and a CTE of the ferrite core. For example, the CTE of the intermediate plate can be within ±3 10⁻⁶/° C. of an average CTE of the mounting surface CTE and the ferrite core CTE. For example, the intermediate plate can be composed of a stainless steel in order to minimize strain imparted on a ceramic ferrite core by an aluminum mounting surface.

### II. Example Systems

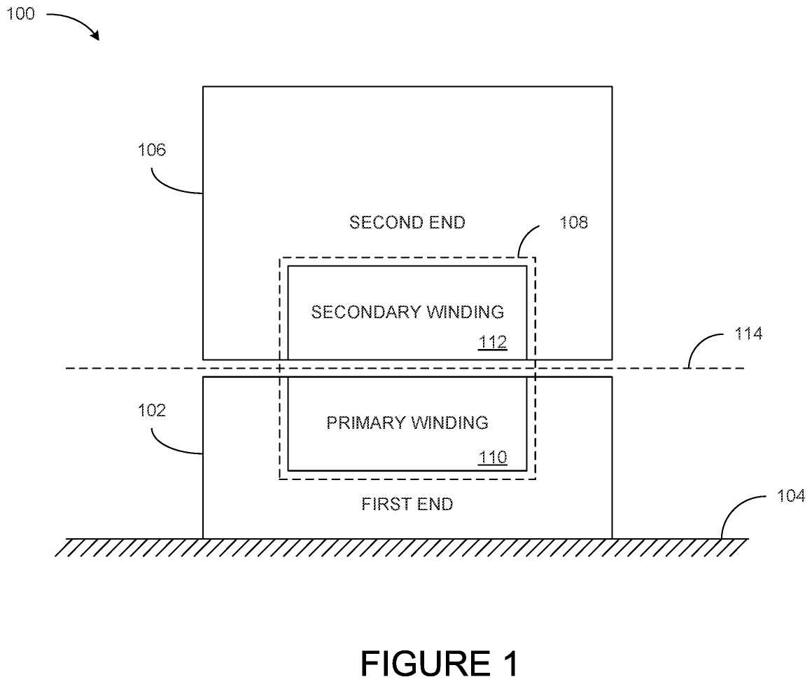

FIG. 1 is a block diagram of a device 100, according to an example embodiment. in particular, FIG. 1 shows device 100 having a first end 102 that is coupled to a stationary surface 104, and a second end 106 that is movable (e.g., rotatable) relative to the stationary surface. In this context, stationary is referred to relative to device 100.

The device 100 further includes a transformer 108 that spans a space 114 (e.g., an air gap) separating the first end 102 and second end 106. Transformer 108 includes a primary winding 110 disposed on the first end 102 and a secondary winding 112 disposed on the second end 106. Within examples, primary 110 and secondary winding 112 can include a plurality of sets of windings. For example, a first set of windings may be used for transmitting power between first end 102 and second end 106, and a second set of windings can be used for transmitting data between first end 102 and second end 106.

The transformer 108 can be used to transfer power and/or data from the primary winding 110 in the first end 102 to the secondary winding in the second end 106 in accordance with a modulation scheme. In turn, the secondary winding 112 may transfer the power and/or data to one or more components of the device 100. Similarly, the secondary winding may transfer data, such as sensor data, to the first end 102 via the primary winding 110. For example, a gyroscopic module of a vehicle or a LIDAR device on a vehicle may be configured in this manner to allow movement relative to a surface of the vehicle and also allow for power and information to be transmitted.

Though FIG. 1 is described with respect to a device 100 having a stationary first end and a movable second end providing a context for use of a transformer, it should be understood that other contexts for using a transformer to transmit power and information across a space are possible.

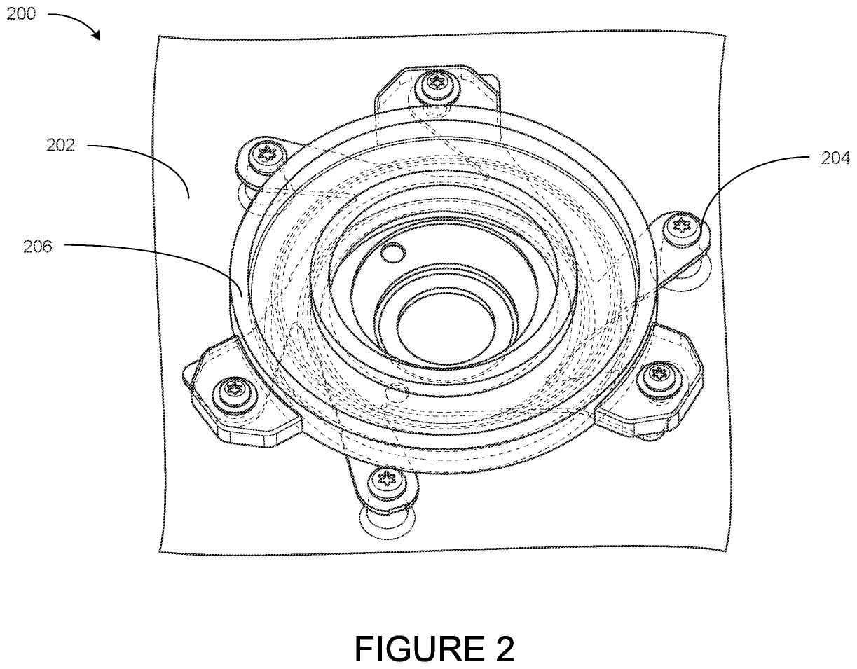

FIG. 2 illustrates a perspective view of a system 200, according to an example embodiment. System 200 includes a mounting surface 202, an intermediate plate 204 that is coupled to mounting surface 202, and a ferrite core 206 that is coupled to the intermediate plate 204. The mounting surface 202 may correspond to stationary surface 104, or another surface to which a device is mounted.

Mounting surface 202 may include a first material having a first coefficient of thermal expansion (CTE). For example, mounting surface 202 may be an aluminum surface on a vehicle or on a first end of a device mounted to a vehicle. Intermediate plate 204 may include a second material having a second CTE, and ferrite core 206 may include a third material having a third CTE.

A difference between the first CTE and the third CTE may cause mounting surface 202 and ferrite core 206 to respond differently to changing thermal conditions. In some scenarios where ferrite core 206 is mounted directly on mounting surface 202, this difference may be significant enough to impart a strain on ferrite core 206 that ferrite core 206 is not designed to endure. This may result in ferrite core 206 breaking, chipping, or degrading in another manner. For example, ferrite core 206 may he composed of or may include a ceramic material that does not expand or contract at the same rate as aluminum when exposed to changing thermal conditions.

Intermediate plate 204 is designed in a manner to reduce the level of strain imparted on ferrite core 206 using a second material having a second CTE that is between the first CTE and the third CTE. In this manner, intermediate plate 204 and ferrite core 206 share a force imparted by mounting surface 202 as a result of changing thermal conditions and different thermal expansion properties of components in system 200. For example, intermediate plate 204 may include a stainless steel material having a CTE between that of aluminum and ceramic material.

In various examples provided herein, a CTE, is referred to as being between two other CTEs. In general, this refers to a constant value associated with thermal expansion of a material being more than a constant value of one material, and less than a constant value of another material. For example, the first CTE can be between 21 and 25 10⁻⁶/° C., the second CTE is between 15 and 19 10⁻⁶/° C., and the third CTE can be between 10 and 14 10⁻⁶/° C. In this example the second CTE is between the first CTE, and the second CTE. As another example, the second CTE can be within ±3 10⁻⁶/° C. of an average CTE of the first CTE and the third CTE. In this example, the average value ±3 10⁻⁶/° C. may be between the first CTE and the second CTE. Materials can be selected for assembling a system similar to system 200 based on CTE values and other relevant properties such as strength, hardness, etc.

Though system 200, and the following description herein, describe a ferrite core that may degrade due to having different thermal expansion characteristics than those of surface on which it is mounted, it should be understood that similar benefits may be achieved in different systems by using an intermediate plate having a CTE between a CTE of a mounting surface and a CTE of another component coupled to the intermediate plate.

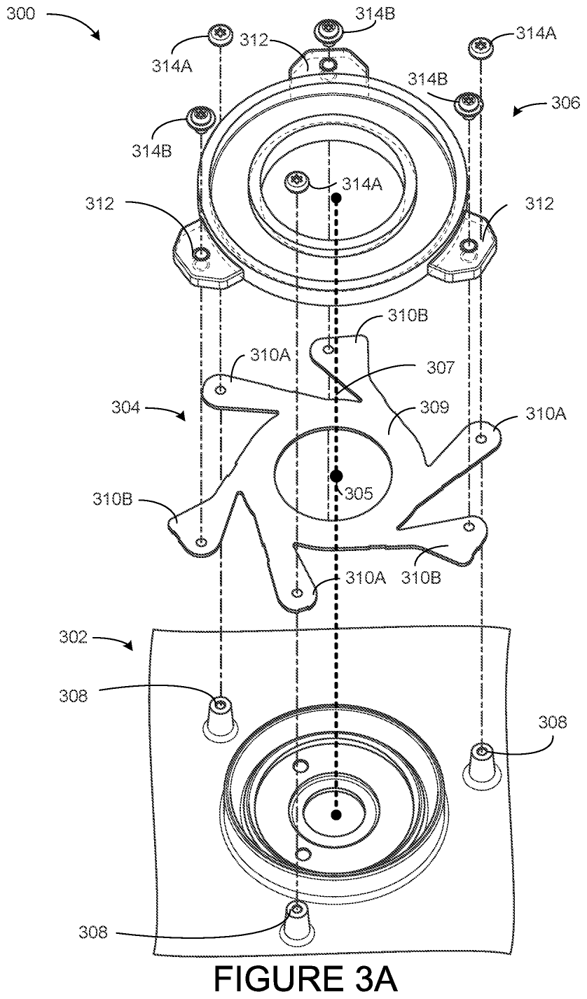

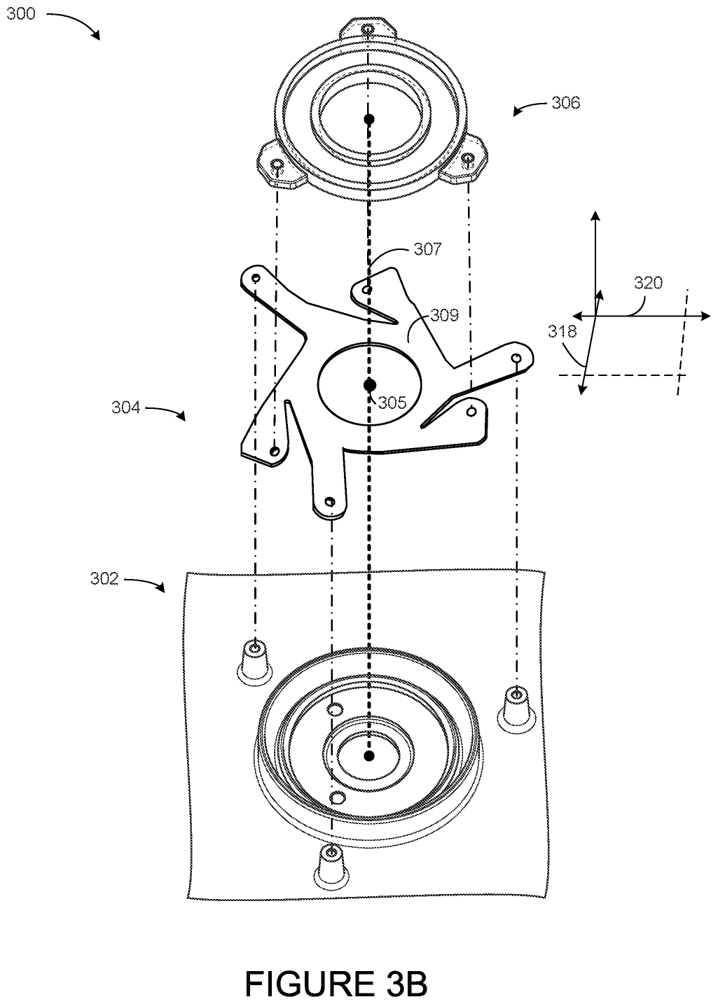

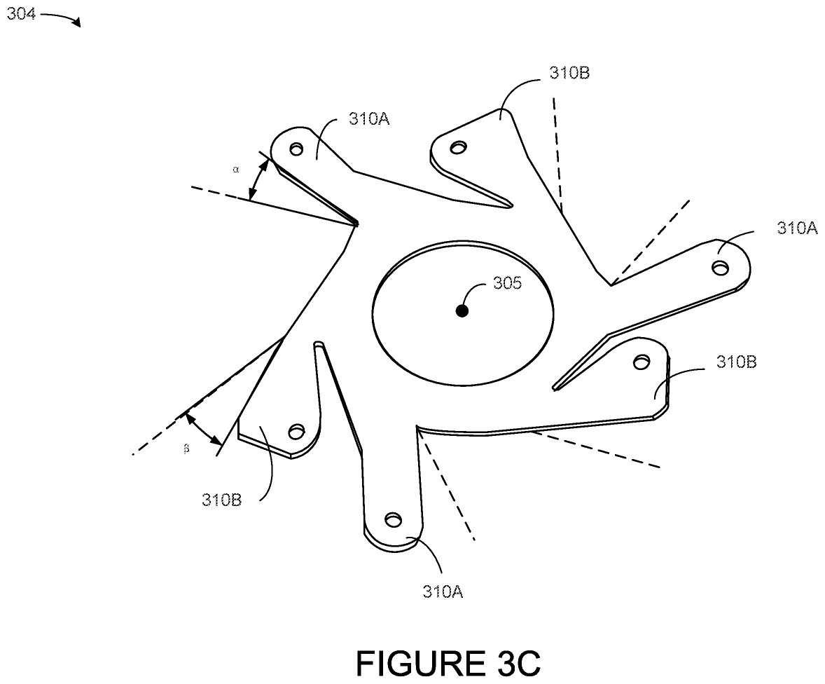

FIG. 3A illustrates an exploded view of a system 300 in first thermal conditions, according to an example embodiment. In particular, FIG. 3A shows a mounting surface 302, an intermediate plate 304, and a ferrite core 306 at a normal operating temperature of system 300. For example, the first thermal conditions may correspond to room temperature (e.g., around 20-22° C.). Mounting surface 302, intermediate plate 304, and ferrite core 306 may be configured such that a minimal force is imparted between mounting surface 302 and ferrite core 306 at the normal temperature. In this manner, system 300 may ensure that ferrite core 306 typically does not experience added strain as a result of thermal expansion.

Mounting surface 302 includes a plurality of mounting points 308. Mounting points 308 are locations on the mounting surface 302 configured to couple to intermediate plate 304. For example, as shown in FIG. 3A, the mounting points 308 are configured to receive a screw or a bolt in order to fasten intermediate plate 304 to mounting surface 302.

Intermediate plate 304 includes a center portion 309 that is centered on a center point 305 of intermediate plate 304. Intermediate plate 304 further includes a plurality of arms extending from center portion 309. In the present example, there are two types of arms, first arms 310A, which are configured to couple to mounting points 308 on mounting surface 302, and second arms 310B, which are configured to couple to mounting points 312 on ferrite core 306. The center portion 309 may additionally or alternatively couple to ferrite core 306 (e.g., using an adhesive). Accordingly, in some examples, ferrite core 306 can be mounted to intermediate plate 304 on center portion 309, and intermediate plate 304 can be mounted to mounting surface 302 via an outer portion surrounding center portion 309 (e.g., a portion that includes first arms 310A).

As shown in FIG. 3A, the arms are arranged in a helical orientation relative to center point 305 and center portion 309. This may allow the arms to act in a similar manner to a spring, so that ferrite core 306 remains stationary in various thermal conditions. In this manner, intermediate plate 304 and ferrite core 306 can be suspended above mounting surface 302 to further minimize forces imparted on ferrite core 306.

Ferrite core 306 includes a plurality of mounting points 312 configured to couple to intermediate plate 304 at second arms 310B. As shown in FIG. 3A, ferrite core 306 is centered above center point 305 of intermediate plate 304. Further, mounting surface 302, intermediate plate 304, and ferrite core 306 are collectively aligned on a center axis 307 that extends through center point 305. In particular, ferrite core 306 is centered on intermediate plate 304, and intermediate plate 304 is centered on mounting points 308 of mounting surface 302.

A plurality of mounting members are configured to couple mounting surface 302, intermediate plate 304, and ferrite core 306. As shown in FIG. 3A, the mounting members include first mounting members 314A configured to couple first arms 310A to mounting points 308, and second mounting members 314B configured to couple second arms 310B to mounting points 312 on ferrite core 306. Though the mounting members are depicted as being bolts, other ways coupling mounting surface 302, intermediate plate 304, and ferrite core 306 together are possible.

FIG. 3B illustrates an exploded view of system 300 in second thermal conditions, according to an example embodiment. In particular, FIG. 300 shows an example in which system 300 experiences an increased temperature relative to the first thermal conditions. To illustrate this change in thermal conditions, mounting surface 302 is depicted as having increased in size relative to intermediate plate 304 and ferrite core 306, and intermediate plate 304 has increased in size relative to ferrite core 306. As described above, this difference in size in changing thermal conditions can be attributed to mounting surface 302 having a first CTE, intermediate plate 304 having a second CTE, and ferrite core 306 having a third CTE, where the first CTE is greater than the second CTE and the second CTE is greater than the third CTE.

The change in relative size of the components in system 300 is also illustrated in deflection in the arms on intermediate plate 304 relative to their positions in FIG. 3A, which is described in further detail below with respect to FIG. 3C.

As described above with respect to FIG. 3A, orienting the arms of intermediate plate 304 in a helical orientation relative to center portion 309 allows mounting surface 302, intermediate plate 304, and ferrite core 306 to collectively remain aligned on a center axis 307 that extends through center point 305. Accordingly, ferrite core 306 has not moved laterally along first lateral direction 318 or second lateral direction 320 relative to intermediate plate 304 or mounting surface 302. In the context of a transformer, this may allow primary windings associated with ferrite core 306 to remain aligned with secondary windings on a movable portion of the device, so that the transfer of power and/or data can continue even in changing thermal conditions.

FIG. 3C illustrates intermediate plate 304 in the second thermal conditions, according to an example embodiment. In particular, FIG. 3C illustrates deflection in the arms of intermediate plate 304 resulting from different CTEs of mounting surface 302, intermediate plate 304, and ferrite core 306. In FIG. 3C dashed lines are provided to illustrate an initial position of the arms in FIG. 3A, and angles α and β respectively illustrate a change in orientation of first arms 310A and second arms 310B in response to changing thermal conditions. As shown in FIG. 3C, angles α and β are equal or nearly equal, indicating that the difference in CTE between mounting surface 302 and intermediate plate 304 is equal to, or nearly equal to, the different in CTE between intermediate plate 304 and ferrite core 306.

The deflections shown by angles α and β also illustrate how a force associated with deflecting the arms is shared between intermediate plate 304 and ferrite core 306. Mounting surface 302 imparts a total force collectively experienced by intermediate plate 304 and ferrite core 306. However, some of this force is applied to first arms 310A via mounting points 308, and a remaining portion of the force is applied to second arms 310B at mounting points 312. In this manner, a force imparted by mounting surface 302 to ferrite core 306 is lessened.

Further, as shown in FIG. 3B, the arms are arranged in a manner that maintains the position of ferrite core 306 relative to center point 305, even in changing thermal conditions. Accordingly, at a first thermal state (e.g., a thermal state of device 100, system 200, or system 300), the ferrite core is centered on the intermediate plate, and, at a second thermal state (e.g., a thermal state of device 100, system 200, or system 300) that is different from the first thermal state, the ferrite core remains centered on the intermediate plate.

It should be understood that FIG. 3C illustrates a potentially exaggerated deflection of the arms for purposes of illustration. In practice, the percentage of expansion of the mounting surface might be less pronounced (e.g., less than 5% expansion), and resulting mechanical forces between mounting surface 302 and intermediate plate 304 will be correspondingly lessened, resulting in less deflection of the arms.

Though FIGS. 3A-C show a particular implementation of using an intermediate plate to lessen forces experienced by a ferrite core due to thermal expansion of a mounting surface, it should be understood that other implementations are possible. More generally, intermediate plate 304 may include a center portion and an outer portion. The outer portion may include arms, a mesh network, springs, coils, or other ways of centering the ferrite core while also reducing forces experienced by the ferrite core.

### III. Example Methods

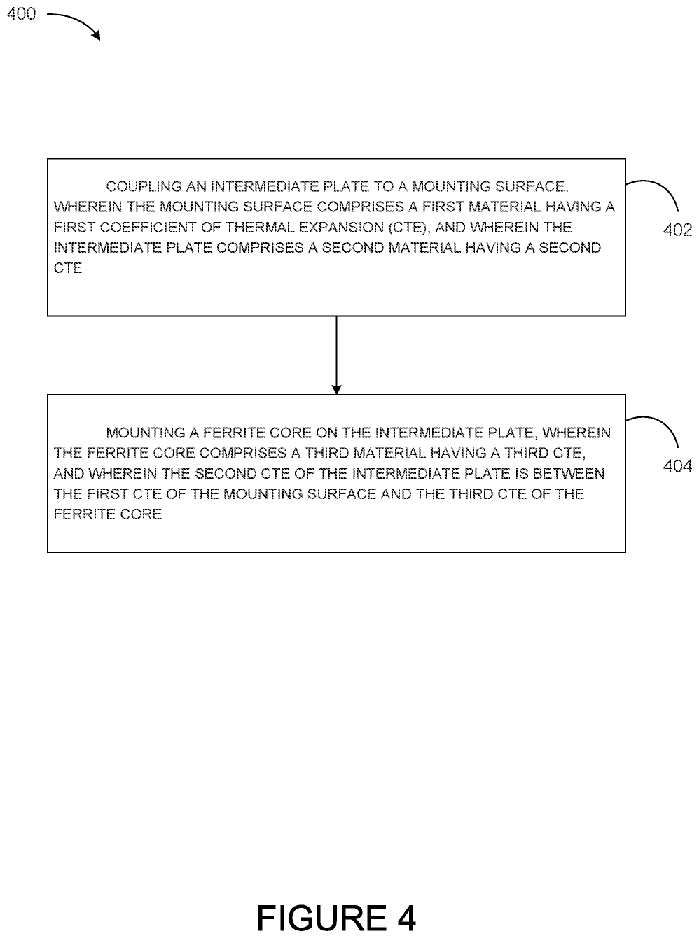

FIG. 4 is a block diagram of a method, according to an example embodiment. In particular, FIG. 4 depicts a method 400 for use in assembling, manufacturing, or installing a device (e.g., device 100). Method 400 may be implemented in accordance with a device 100, system 200, or system 300, or the description thereof. Aspects of the functions of method 400 may be performed automatically by a computing device or a computing device controlling a mechanism (e.g., a robot or a controllable arm), and other aspects may be performed manually. In some examples, each block of method 400 may be performed automatically by a computing device or a computing device controlling a mechanism, and in other examples, each block of method 400 may be performed manually.

A computing device used in performing method 400 may include one or more processors, a memory, and instructions stored on the memory and executable by the processor(s) to perform functions. The processor(s) can include on or more processors, such as one or more general-purpose microprocessors and/or one or more special purpose microprocessors. The one or more processors may include, for instance, an application-specific integrated circuit (ASIC) or a field-programmable gate array (FPGA). Other types of processors, computers, or devices configured to carry out software instructions are contemplated herein.

The memory may include a computer readable medium, such as a non-transitory computer readable medium, which may include without limitation, read-only memory (ROM), programmable read-only memory (PROM), erasable programmable read-only memory (EPROM), electrically erasable programmable read-only memory (EEPROM), non-volatile random-access memory (e.g., flash memory), a solid state drive (SSD), a hard disk drive (HDD), a Compact Disc (CD), a Digital Video Disk (DVD), a digital tape, read/write (R/W) CDs, R/W DVDs, etc. Other types of storage devices, memories, and media are contemplated herein.

At block 402, method 400 includes, coupling an intermediate plate to a mounting surface. For example, the intermediate plate may include an outer portion that includes one or more arms (e.g., first arms 310A), and the intermediate place can be mounted on the mounting surface using the one or more arms. The mounting surface includes a first material having a first coefficient of thermal expansion (CTE), and the intermediate plate includes a second material having a second CTE.

At block 404, method 400 includes mounting a ferrite core on the intermediate plate. For example, the ferrite core can he mounted to arms (e.g., second arms 310B) on the intermediate plate. The ferrite core includes a third material having a third CTE, and the second CTE of the intermediate plate is between the first CTE of the mounting surface and the third CTE of the ferrite core.

Within examples, the intermediate plate includes an outer portion and a center portion. In these examples, coupling the intermediate plate to a mounting surface includes coupling the outer portion to the mounting surface, and mounting the ferrite core on the intermediate plate includes mounting the ferrite on the center portion of the intermediate plate.

Within examples, method 400 may further include determining a material to use for the intermediate plate based on the first material and the second material. For example, a computing device may access a database of materials and corresponding CTEs, determine the first CTE of the first material (e.g., a material of a mounting surface, determine a second CTE of the second material (e.g., a material of a component to couple to the mounting surface), and select a material having a CTE between the first CTE and the second CTE to be used for the intermediate plate.

In further examples, method 400 may further include, prior to determining a material for the intermediate plate, determining strain tolerance characteristics of a component (e.g., a ferrite core) that is to be mounted on the mounting surface, determining a projected force imparted by the mounting surface to the component based on CTEs of the mounting surface and the component, and determining whether the projected force exceeds a threshold force associated with the strain tolerance. Method 400 may further include determining to use an intermediate plate based on the projected force exceeding the threshold force associated with the strain tolerance. Within examples, determining the material of the intermediate plate may be based on the strain tolerance of the component.

Though a ferrite core is described as being coupled to the mounting surface described above, and particular materials and CTEs are provided to illustrate examples involving using an intermediate plate to reduce strain imparted on a ferrite core, other materials may be used when mounting other types of components to other types of mounting surfaces. For example, rather than a ferrite core, a metallic component for mounting a rotating end of a rotating radar, a rotating camera, a rotating antenna, or another component can be attached to an intermediate plate. Other types of mounting components are possible.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, a physical computer (e.g., a field programmable gate array (FPG) or application-specific integrated circuit (ASIC)), or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A device comprising:
a mounting surface comprising a first material having a first coefficient of thermal expansion (CTE);
an intermediate plate coupled to the mounting surface and comprising a second material having a second CTE; and
a ferrite core coupled to the intermediate plate and comprising a third material having a third CTE, wherein the second CTE of the intermediate plate is between the first CTE of the mounting surface and the third CTE of the ferrite core.

2. The device of claim 1, wherein the ferrite core is centered on the intermediate plate.

3. The device of claim 1, wherein, at a first thermal state of the device, the ferrite core is centered on the intermediate plate, and wherein, at a second thermal state of the device that is different from the first thermal state, the ferrite core remains centered on the intermediate plate.

4. The device of claim 1, wherein the intermediate plate comprises a center portion and an outer portion, wherein the ferrite core is mounted to the intermediate plate on the center portion, and wherein the intermediate plate is mounted to the mounting surface via the outer portion.

5. The device of claim 4, wherein the outer portion comprises a plurality of arms extending from the center portion, and wherein each arm is coupled to a respective mounting point on the mounting surface.

6. The device of claim 5, wherein the arms are configured in a helical orientation relative to the center portion.

7. The device of claim 6, wherein the center portion is suspended above the mounting surface by the arms.

8. The device of claim 1, wherein the first material comprises aluminum, wherein the second material comprises stainless steel, and wherein the third material comprises a ceramic material.

9. The device of claim 1, wherein the first CTE is between 21 and 25 10⁻⁶/° C., wherein the second CTE is between 15 and 19 10⁻⁶/° C., and wherein the third CTE is between 10 and 14 10⁻⁶/° C.

10. The device of claim 1, wherein the second CTE is within ±3 10⁻⁶/° C. of an average CTE of the first CTE and the third CTE.

11. The device of claim 1, wherein thermal expansion of the mounting surface imparts a total mechanical force to the intermediate plate and the ferrite core, and wherein the intermediate plate imparts a portion of the total mechanical force to the ferrite core,

12. An intermediate plate comprising:
an outer portion coupled to a mounting surface, wherein the mounting surface comprises a first material having a first coefficient of thermal expansion (CTE); and
a center portion coupled to a ferrite core,
wherein the outer portion and the center portion each comprise a second material having a second CTE, wherein the ferrite core comprises a third material having a third CTE, and wherein the second CTE of the intermediate plate is between the first CTE of the mounting surface and the third CTE of the ferrite core.

13. The intermediate plate of claim 12, wherein the outer portion comprises a plurality of arms extending from the center portion, and wherein each arm is coupled to a respective mounting point on the mounting surface.

14. The intermediate plate of claim 13, wherein the arms are configured in a helical orientation relative to the center portion.

15. The intermediate plate of claim 14, wherein the center portion is suspended above the mounting surface by the arms.

16. The intermediate plate of claim 12, wherein the first material comprises aluminum, wherein the second material comprises stainless steel, and wherein the third material comprises a ceramic material.

17. The intermediate plate of claim 12, wherein the first CTE is between 21 and 25 10⁻⁶/° C., wherein the second CTE is between 15 and 19 10⁻⁶/° C., and wherein the third CTE is between 10 and 14 10⁻⁶/° C.

18. The intermediate plate of claim 12, wherein the second. CTE is within 3 10⁻⁶/° C. of an average CTE of the first CTE and the third CTE.

19. A method comprising:
coupling an intermediate plate to a mounting surface, wherein the mounting surface comprises a first material having a first coefficient of thermal expansion (CTE), and wherein the intermediate plate comprises a second material having a second CTE; and
mounting a ferrite core on the intermediate plate, wherein the ferrite core comprises a third material having a third CTE, and wherein the second CTE of the intermediate plate is between the first CTE of the mounting surface and the third CTE of the ferrite core.

20. The method of claim 19, wherein the intermediate plate comprises an outer portion and a center portion,
wherein coupling the intermediate plate to a mounting surface comprises coupling the outer portion to the mounting surface, and
wherein mounting the ferrite core on the intermediate plate comprises mounting the ferrite core on the center portion of the intermediate plate.
